(19) United States
(12) Patent Application Publication
(10) Pub. No.: US 2024/0404198 A1
(43) Pub. Date: Dec. 5, 2024

(54) RECOGNITION SYSTEM, RECOGNITION DEVICE, RECOGNITION METHOD, AND PROGRAM PRODUCT

(71) Applicant: DENSO CORPORATION, Kariya-city (JP)

(72) Inventors: YOSHIHISA SHIBATA, Kariya-city (JP); SUGURU YAMAZAKI, Kariya-city (JP); SHUN SHIMIZU, Kariya-city (JP); KENJI MUTO, Kariya-city (JP)

(21) Appl. No.: 18/803,237

(22) Filed: Aug. 13, 2024

Related U.S. Application Data
(63) Continuation of application No. PCT/JP2022/041385, filed on Nov. 7, 2022.

(30) Foreign Application Priority Data
Feb. 15, 2022 (JP) 2022-021553
Sep. 19, 2022 (JP) 2022-148667

(51) Int. Cl. G06T 17/05; G06V 10/764

(52) U.S. Cl. CPC G06T 17/05; G06V 10/764; G06V 2201/07

(57) ABSTRACT

The present disclosure provides a recognition technology to be executed by a processor. The processor, by executing a program stored in a computer-readable non-transitory storage, is configured to recognize, in a scan space, a target moving object that is movable in the scan space by scanning the target moving object using a scanning device mounted on a host moving object; acquire three-dimensional scan data representing a scan point group generated by scanning of the scan space; read, from a storage medium, a three-dimensional dynamic map representing a mapping point group generated by mapping of an object present in the scan space; and cluster the scan point group based on identification information for identifying a state of the scan space in each of multiple three-dimensional voxels into which the scan space is divided in the three-dimensional dynamic map and generate recognition data by recognizing the target moving object.

### CROSS REFERENCE TO RELATED APPLICATIONS

The present application is a continuation application of International Patent Application No. PCT/JP2022/041385 filed on Nov. 7, 2022, which designated the U.S. and claims the benefit of priority from Japanese Patent Application No. 2022-021553 filed on Feb. 15, 2022 and Japanese Patent Application No. 2022-148667 filed on Sep. 19, 2022. The entire disclosures of all of the above applications are incorporated herein by reference.

### TECHNICAL FIELD

The present disclosure relates to a recognition technology for recognizing a moving object.

### BACKGROUND

In recent years, a recognition technology for recognizing a moving object, which is movable in a scan space, has become important. The scan space is scanned by a scanning device.

### SUMMARY

The present disclosure provides a recognition technology to be executed by a processor. The processor, by executing a program stored in a computer-readable non-transitory storage, is configured to recognize, in a scan space, a target moving object that is movable in the scan space by scanning the target moving object using a scanning device mounted on a host moving object; acquire three-dimensional scan data representing a scan point group generated by scanning of the scan space; read, from a storage medium, a three-dimensional dynamic map representing a mapping point group generated by mapping of an object present in the scan space; and cluster the scan point group based on identification information for identifying a state of the scan space in each of multiple three-dimensional voxels into which the scan space is divided in the three-dimensional dynamic map and generate recognition data by recognizing the target moving object.

### BRIEF DESCRIPTION OF DRAWINGS

Objects, features and advantages of the present disclosure will become apparent from the following detailed description made with reference to the accompanying drawings. In the drawings:

FIG. 1 is a block diagram illustrating an overall configuration of a recognition system according to a first embodiment;

FIG. 2 is a schematic diagram illustrating a relationship between a scanning device of a host moving object and a target moving object according to the first embodiment;

FIG. 3 is a block diagram illustrating a functional configuration of the recognition system according to the first embodiment;

FIG. 4 is a flow chart illustrating a recognition flow according to the first embodiment;

FIG. 5 is a schematic diagram for illustrating the recognition flow according to the first embodiment;

FIG. 6 is a schematic diagram for illustrating the recognition flow according to the first embodiment;

FIG. 7 is a schematic diagram for illustrating the recognition flow according to the first embodiment;

FIG. 8 is a schematic diagram for illustrating the recognition flow according to the first embodiment;

FIG. 9 is a schematic diagram for illustrating the recognition flow according to the first embodiment;

FIG. 10 is a schematic diagram for illustrating the recognition flow according to the first embodiment;

FIG. 11 is a schematic diagram for illustrating the recognition flow according to the first embodiment;

FIG. 12 is a flow chart illustrating a normal extraction subroutine in the recognition flow according to the first embodiment;

FIG. 13 is a flow chart illustrating a front-rear extraction subroutine in the recognition flow according to the first embodiment;

FIG. 14 is a flow chart illustrating an overlap extraction subroutine in the recognition flow according to the first embodiment;

FIG. 15 is a flow chart illustrating a fixed-point extraction subroutine in the recognition flow according to the first embodiment;

FIG. 16 is a flow chart illustrating a normal recognition subroutine in the recognition flow according to the first embodiment;

FIG. 17 is a flow chart illustrating a front-rear recognition subroutine in the recognition flow according to the first embodiment;

FIG. 18 is a flow chart illustrating an overlap recognition subroutine in the recognition flow according to the first embodiment;

FIG. 19 is a schematic diagram for illustrating the recognition flow according to the first embodiment;

FIG. 20 is a schematic diagram for illustrating a recognition flow according to a second embodiment;

FIG. 21 is a schematic diagram for illustrating the recognition flow according to the second embodiment;

FIG. 22 is a schematic diagram for illustrating the recognition flow according to the second embodiment;

FIG. 23 is a flow chart illustrating a high-reflection extraction subroutine in the recognition flow according to the second embodiment; and

FIG. 24 is a flow chart illustrating a high-reflection recognition subroutine in the recognition flow according to the second embodiment.

### DETAILED DESCRIPTION

In a related art, a three-dimensional distance image data is compared with a three-dimensional environment map data. Then, in the three-dimensional distance image data, a point group that is not present in the three-dimensional environment map data is clustered to recognize a moving object.

However, in the above related art, between multiple stationary objects which are spaced apart from each other in front-rear relation along a scan direction of a laser distance meter serving as a scanning device, due to overlap of scan echoes from those individual stationary objects, an erroneous scan point group referred to as ghost pixels may be formed. In this case, it becomes difficult to separate a normal point group corresponding to the moving object that has entered between the individual stationary objects from the erroneous scan point group by clustering, and accordingly accuracy of recognition of the entered moving object deteriorates. Such a problem may also arise between multiple moving objects which are overlapped when viewed in the scan direction of the laser distance meter.

According to a first aspect of the present disclosure, a recognition system includes a computer-readable non-transitory storage medium, and a processor, by executing a program stored in the computer-readable non-transitory storage, configured to recognize, in a scan space, a target moving object that is movable in the scan space by scanning the target moving object using a scanning device mounted on a host moving object. The processor is configured to: acquire three-dimensional scan data representing a scan point group generated by scanning of the scan space; read, from a storage medium, a three-dimensional dynamic map representing a mapping point group generated by mapping of an object present in the scan space; and cluster the scan point group based on identification information for identifying a state of the scan space in each of multiple three-dimensional voxels into which the scan space is divided in the three-dimensional dynamic map and generate recognition data by recognizing the target moving object present between multiple stationary objects which are spaced apart from each other in front-rear relation along a scan direction of the scanning device in the scan space.

According to a second aspect of the present disclosure, a recognition device mountable on a host moving object includes a computer-readable non-transitory storage medium, and a processor, by executing a program stored in the computer-readable non-transitory storage, configured to recognize, in a scan space, a target moving object that is movable in the scan space by scanning the target moving object using a scanning device mounted on the host moving object. The processor is configured to: acquire three-dimensional scan data representing a scan point group generated by scanning of the scan space; read, from a storage medium, a three-dimensional dynamic map representing a mapping point group generated by mapping of an object present in the scan space; and cluster the scan point group based on identification information for identifying a state of the scan space in each of multiple three-dimensional voxels into which the scan space is divided in the three-dimensional dynamic map and generate recognition data by recognizing the target moving object present between multiple stationary objects which are spaced apart from each other in front-rear relation along a scan direction of the scanning device in the scan space.

According to a third aspect of the present disclosure, a recognition method to be executed by a processor is provided to recognize, in a scan space, a target moving object that is movable in the scan space by scanning the target moving object using a scanning device mounted on a host moving object. The recognition method includes: acquiring three-dimensional scan data representing a scan point group generated by scanning of the scan space; reading, from a storage medium, a three-dimensional dynamic map representing a mapping point group generated by mapping of an object present in the scan space; clustering the scan point group based on identification information for identifying a state of the scan space in each of multiple three-dimensional voxels into which the scan space is divided in the three-dimensional dynamic map; and generating recognition data by recognizing the target moving object present between multiple stationary objects which are spaced apart from each other in front-rear relation along a scan direction of the scanning device in the scan space.

According to a fourth aspect of the present disclosure, a recognition program product stored in a computer-readable non-transitory storage medium is provided. The recognition program product includes instructions to be executed by a processor to recognize, in a scan space, a target moving object that is movable in the scan space by scanning the target moving object using a scanning device mounted on a host moving object. The instructions include: acquiring three-dimensional scan data representing a scan point group generated by scanning of the scan space; reading, from a storage medium, a three-dimensional dynamic map representing a mapping point group generated by mapping of an object present in the scan space; clustering the scan point group based on identification information for identifying a state of the scan space in each of multiple three-dimensional voxels into which the scan space is divided in the three-dimensional dynamic map; and generating recognition data by recognizing the target moving object present between multiple stationary objects which are spaced apart from each other in front-rear relation along a scan direction of the scanning device in the scan space.

In the above first to fourth aspects, the recognition data, which is based on the recognition of the target moving object present between the multiple stationary objects which are spaced apart from each other in the front-rear relation in the scan direction of the scanning device in the scan space, is generated. At this time, according to the first to fourth aspects, by being based on the identification information for identifying the state of the scan space in each of the multiple three-dimensional voxels into which the scan space is divided in the three-dimensional dynamic map, it is possible to exclude the erroneous scan point group from the scan point groups clustered correspondingly to the spaces between the multiple stationary objects in the three-dimensional scan data. Therefore, it is possible to recognize the target moving object that has entered between the multiple stationary objects.

According to a fifth aspect of the present disclosure, a recognition system includes a computer-readable non-transitory storage medium, and a processor, by executing a program stored in the computer-readable non-transitory storage, configured to recognize, in a scan space, target moving objects that are movable in the scan space by scanning the target moving objects using a scanning device mounted on a host moving object. The processor is configured to: acquire three-dimensional scan data representing a scan point group generated by scanning of the scan space; read, from a storage medium, a three-dimensional dynamic map representing a mapping point group generated by mapping of an object present in the scan space; and cluster the scan point group based on identification information for identifying a state of the scan space in each of multiple three-dimensional voxels into which the scan space is divided in the three-dimensional dynamic map and generate recognition data by recognizing the target moving objects, which are overlapped with one another in the scan space when viewed in a scan direction of the scanning device.

According to a sixth aspect of the present disclosure, a recognition device mountable on a host moving object includes a computer-readable non-transitory storage medium, and a processor, by executing a program stored in the computer-readable non-transitory storage, configured to recognize, in a scan space, target moving objects that are movable in the scan space by scanning the target moving objects using a scanning device mounted on the host moving object. The processor is configured to: acquire three-dimensional scan data representing a scan point group generated by scanning of the scan space; read, from a storage medium, a three-dimensional dynamic map representing a mapping point group generated by mapping of an object present in the scan space; and cluster the scan point group based on identification information for identifying a state of the scan space in each of multiple three-dimensional voxels into which the scan space is divided in the three-dimensional dynamic map and generate recognition data by recognizing the target moving objects, which are overlapped with one another in the scan space when viewed in a scan direction of the scanning device.

According to a seventh aspect of the present disclosure, a recognition method to be executed by a processor is provided to recognize, in a scan space, target moving objects that are movable in the scan space by scanning the target moving objects using a scanning device mounted on a host moving object. The recognition method includes: acquiring three-dimensional scan data representing a scan point group generated by scanning of the scan space; reading, from a storage medium, a three-dimensional dynamic map representing a mapping point group generated by mapping of an object present in the scan space; clustering the scan point group based on identification information for identifying a state of the scan space in each of multiple three-dimensional voxels into which the scan space is divided in the three-dimensional dynamic map; and generating recognition data by recognizing the target moving objects, which are overlap with one another in the scan space when viewed in a scan direction of the scanning device.

According to an eighth aspect of the present disclosure, a recognition program product stored in a computer-readable non-transitory storage medium is provided. The recognition program product includes instructions to be executed by a processor to recognize, in a scan space, target moving objects that are movable in the scan space by scanning the target moving objects using a scanning device mounted on a host moving object. The instructions include: acquiring three-dimensional scan data representing a scan point group generated by scanning of the scan space; reading, from a storage medium, a three-dimensional dynamic map representing a mapping point group generated by mapping of an object present in the scan space; clustering the scan point group based on identification information for identifying a state of the scan space in each of multiple three-dimensional voxels into which the scan space is divided in the three-dimensional dynamic map; and generating recognition data by recognizing the target moving objects, which are overlap with one another in the scan space when viewed in a scan direction of the scanning device.

In the above fifth to eighth aspects, the recognition data, which is based on the recognition of the multiple target moving objects which are overlap with one another in the scan direction when viewed from the scanning device in the scan space, is generated. At this time, according to the fifth to eighth aspects, by being based on the identification information for identifying the state of the scan space in each of the multiple three-dimensional voxels into which the scan space is divided in the three-dimensional dynamic map, it is possible to exclude the erroneous scan point group from the scan point groups clustered correspondingly to the spaces between the multiple target moving objects in the three-dimensional scan data. Therefore, it is possible to recognize, with high accuracy, the individual target moving objects which are overlap with one another when viewed in the scan direction.

### First Embodiment

Hereinafter, on the basis of the drawings, multiple embodiments of the present disclosure will be described. Note that, in each of the embodiments, a repetitive description of the corresponding components in the individual embodiments may be omitted by giving the same reference symbol thereto. In each of the embodiments, when only a part of a configuration is described, to another part of the configuration, a configuration in another previously described embodiment is applicable. In addition, not only a combination of configurations explicitly mentioned in the description of each of the embodiments, but also a partial combination of the configurations in the multiple embodiments can be made even though not explicitly mentioned, as long as the combination has no particular problem.

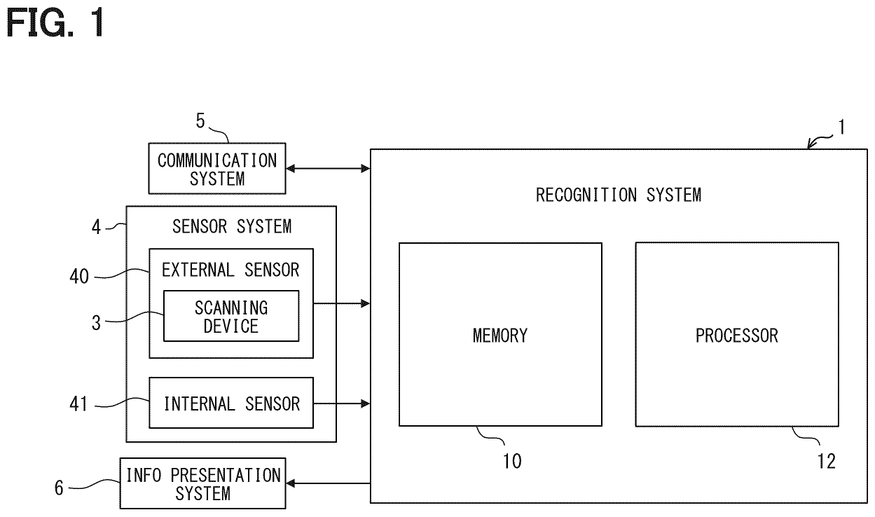

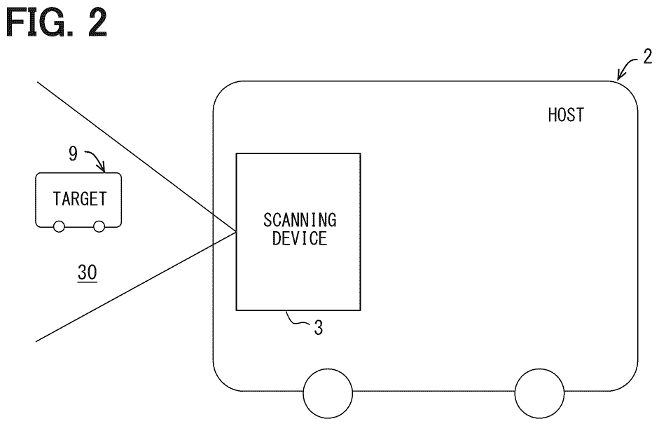

As illustrated in FIG. 2, a recognition system 1 according to a first embodiment illustrated in FIG. 1 recognizes a target moving object 9 movable in a scan space 30 scanned by a scanning device 3 mounted on a host moving object 2. A host moving object 2 to which the recognition system 1 is applied is a vehicle that can travel on a road with an occupant on board, such as, e.g., an automobile. The target moving object 9 to be recognized by the recognition system 1 includes multiple types among, e.g., another vehicle other than the host moving object 2, a motorcycle, a person, an animal, an autonomous robot, a remote travelling robot, and the like.

In the host moving object 2, an automatic driving mode is executed in levels corresponding to degrees of manual intervention by the occupant in dynamic driving tasks. The automatic driving mode may also be implemented by autonomous driving control in which the system during operation executes all the dynamic driving tasks such as conditional driving automation, advanced driving automation, or full driving automation. The automatic driving mode may also be implemented by advanced driving assistance control in which the occupant executes some or all of dynamic driving tasks such as driving assistance or partial driving automation. The automatic driving mode may also be implemented by either one of the autonomous driving control and the advanced driving assistance control, a combination thereof, or switching therebetween.

In the host moving object 2, a sensor system 4, a communication system 5, and an information presentation system 6, which are illustrated in FIG. 1, are mounted. The sensor system 4 acquires, for an external world and an internal world of the host moving object 2, sensor information that can be used to control driving of the host moving object 2 in the recognition system 1. Accordingly, the sensor system 4 is configured to include an external sensor 40 and an internal sensor 41.

The external sensor 40 acquires, as the sensor information, information on the external world corresponding to a peripheral environment of the host moving object 2. The external sensor 40 includes the scanning device 3 that scans the scan space 30 included in the external world of the host moving object 2 to acquire the sensor information. The scanning device 3 is at least one type capable of generating three-dimensional scan data Dt described later among, e.g., a three-dimensional LIDAR (Light Detection and Ranging/Laser Imaging Detection and Ranging), a three-dimensional radar, and the like. Note that the external sensor 40 other than the scanning device 3 may also include at least one type that senses the external world of the host moving object 2 among, e.g., a camera, a sonar, and the like.

It is to be noted herein that the scanning device 3 acquires the sensor information obtained by scanning the scan space 30 (see FIG. 2) determined according to a viewing angle set toward the external world of the host moving object 2 and thereby sensing an object present in the space 30. In particular, the sensor information acquired by the scanning device 3 in the first embodiment is the scan data Dt representing a state of a scan point group resulting from the scanning of the scan space 30 in three dimensions. The scan data Dt includes, e.g., a three-dimensional state value related to at least one type among, e.g., a distance, an azimuth, positional coordinates, a speed, a beam reflection intensity, and the like. Among the state values included in the scan data Dt, the distance represents a value measured by a dTOF (direct Time Of Flight) which is based on a light time between irradiation with a scan beam and reception of a reflected beam. Among the state values included in the scan data Dt, the azimuth represents a scan direction which changes to at least one of a horizontal direction and a vertical direction with respect to the scan space 30.

The internal sensor 41 acquires, as the sensor information, information on the internal world corresponding to an inner environment of the host moving object 2. The internal sensor 41 may also include a physical quantity sensing type which senses a specific kinetic physical quantity in the internal world of the host moving object 2. The internal sensor 41 of the physical quantity type is at least one type among, a running speed sensor, an acceleration sensor, a gyro sensor, and the like. The internal sensor 41 may also include an occupant sensing type which senses a specific state of an occupant in the internal world of the host moving object 2. The internal sensor 41 of the occupant sensing type is at least one type among, e.g., a driver status monitor (registered trademark), a biosensor, a seat occupancy sensor, an actuator sensor, an in-vehicle device sensor, and the like.

The communication system 5 acquires, by wireless communication, communication information which can be used to control the driving of the host moving object 2 in the recognition system 1. The communication system 5 may also include a V2X type which transmits/receives a communication signal to/from a V2X system present in the external world of the host moving object 2. The V2X-type communication system 5 is at least one type among, e.g., DSRC (Dedicated Short Range Communications) communication device, a cellular V2X (C-V2X) communication device, and the like. The communication system 5 may also include a positioning type which receives a positioning signal from an artificial satellite of a GNSS (Global Navigation Satellite System) present in the external world of the host moving object 2. The positioning-type communication system 5 is, e.g., a GNSS receiver or the like. The communication system 5 may also include a terminal communication type which transmits/receives a communication signal to/from a terminal present in the internal world of the host moving object 2. The terminal-communication-type communication system 5 is at least one type among, e.g., a Bluetooth (Bluetooth: registered trademark) device, a Wi-Fi (registered trademark) device, an infrared communication device, and the like.

The information presentation system 6 presents notification information to an occupant in the host moving object 2. The information presentation system 6 may also be of a visual stimulation type which stimulates a visual sense of the occupant with display. The visual-stimulation-type information presentation system 6 is at least one type among, e.g., a HUD (Head-Up Display), a MFD (Multi-Function Display), a combination meter, a navigation unit, and the like. The information presentation system 6 may also be of an auditory stimulation type which auditorily stimulates an auditory sense of the occupant. The auditory-stimulation-type information presentation system 6 is at least one type among, e.g., a speaker, a buzzer, a vibration unit, and the like.

The recognition system 1 is connected to the sensor system 4, the communication system 5, and the information presentation system 6 via at least one type among, e.g., a LAN (Local Area Network) line, a wire harness, an internal bus, a wireless communication line, and the like. The recognition system 1 is configured to include at least one dedicated computer.

The dedicated computer included in the recognition system 1 may also be a recognition control ECU (Electronic Control Unit) that controls recognition of an object present in the scan space 30 on the basis of the scan data Dt serving as the sensor information from the scanning device 3. The recognition control ECU mentioned herein may also have a function of integrating the sensor information from multiple the external sensors 40 each including the scanning device 3. The dedicated computer included in the recognition system 1 may also be a drive control ECU that controls the driving of the host moving object 2. The dedicated computer included in the recognition system 1 may also be a navigation ECU that navigates a driving route of the host moving object 2. The dedicated computer included in the recognition system 1 may also be a locator ECU that estimates self-state quantities including a self-position of the host moving object 2. The dedicated computer included in the recognition system 1 may also be a HCU (HMI (Human Machine Interface) Control Unit) that controls information presentation by the information presentation system 6 in the host moving object 2. The dedicated computer included in the recognition system 1 may also be, e.g., a computer other than the host moving object 2 which builds an external sensor, a mobile terminal, or the like communicative with the communication system 5.

The dedicated computer included in the recognition system 1 includes at least one memory 10 and at least one processor 12. The memory 10 is a non-transitory-tangible storage medium which non-temporarily stores a computer readable program, data, and the like and is at least one type among, e.g., a semiconductor memory, a magnetic medium, an optical medium, and the like. The processor 12 includes, as a core, at least one type among, e.g., a CPU (Central Processing Unit), a GPU (Graphics Processing Unit), a RISC (Reduced Instruction Set Computer)-CPU, a DFP (Data Flow Processor), a GSP (Graph Streaming Processor), and the like.

In the recognition system 1, the memory 10 stores map information which can be used to control the driving of the host moving object 2. The memory 10 acquires and stores latest map information by communication with the external center through the communication system 5 of, e.g., the V2X type or the like. In particular, the map information in the first embodiment is a three-dimensional dynamic map Mt serving as digital data of a high-precision map converted into three-dimensional data to represent the driving environment of the host moving object 2. The dynamic map Mt represents a state of a mapping point group obtained by mapping an object at a fixed-point position present in the scan space 30 of the scanning device 3. The dynamic map Mt includes a three-dimensional state value related to at least one type among, e.g., positional coordinates, a distance, an azimuth, a shape, and the like of a target. An object to be mapped for the dynamic map Mt includes at least multiple types each located at a fixed point among, e.g., a road, a sign, a signal, a structure, a railroad crossing, vegetation, a space partition, a space demarcation line, a marking line, and the like.

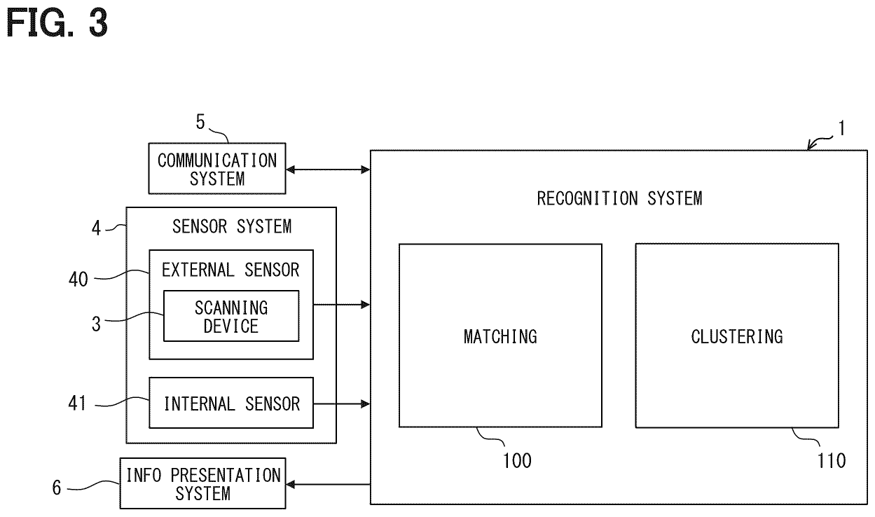

In the recognition system 1, the processor 12 executes multiple instructions included in a recognition program which is stored in the memory 10 to allow recognition of the target moving object 9 movable in the scan space 30 scanned by the scanning device 3 of the host moving object 2. Thus, the recognition system 1 builds multiple functional blocks for recognizing the target moving object 9 in the scan space 30. The multiple functional blocks built in the recognition system 1 includes a matching block 100 and a clustering block 110, as illustrated in FIG. 3.

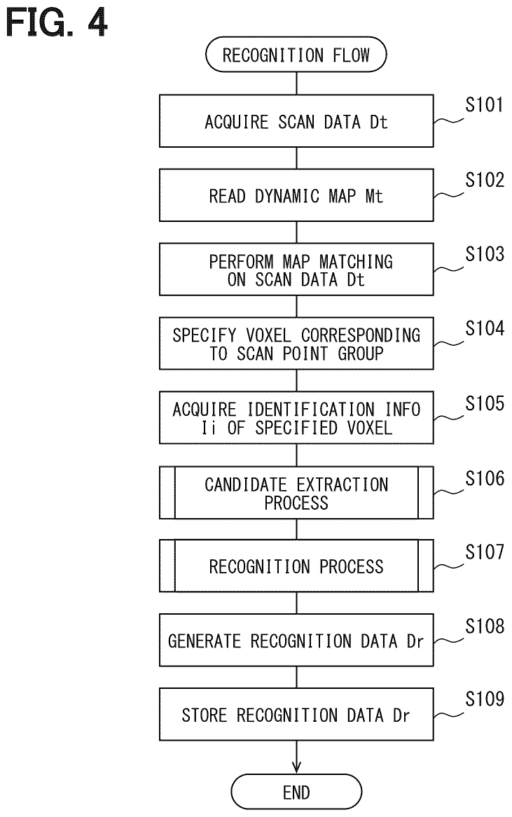

Referring to FIG. 4, the following will describe a flow (hereinafter referred to as a recognition flow) of a recognition method in which, through the cooperation of the individual blocks 100 and 110, the recognition system 1 recognizes the target moving object 9 in the scan space 30. An algorithm cycle of the recognition flow is repeatedly executed during activation of the host moving object 2. Note that each “S” in the recognition flow means each of multiple steps performed according to multiple instructions included in the recognition program.

In S101, the matching block 100 acquires the scan data Dt from the scanning device 3. In S102, the matching block 100 reads, from the memory 10, the dynamic map Mt corresponding to a spot where the scan data Dt is acquired by S101. At this time, the spot where the scan data Dt is acquired may be determined by self-position estimation based on, e.g., information acquired by the sensor system 4 and the communication system 5 or the like.

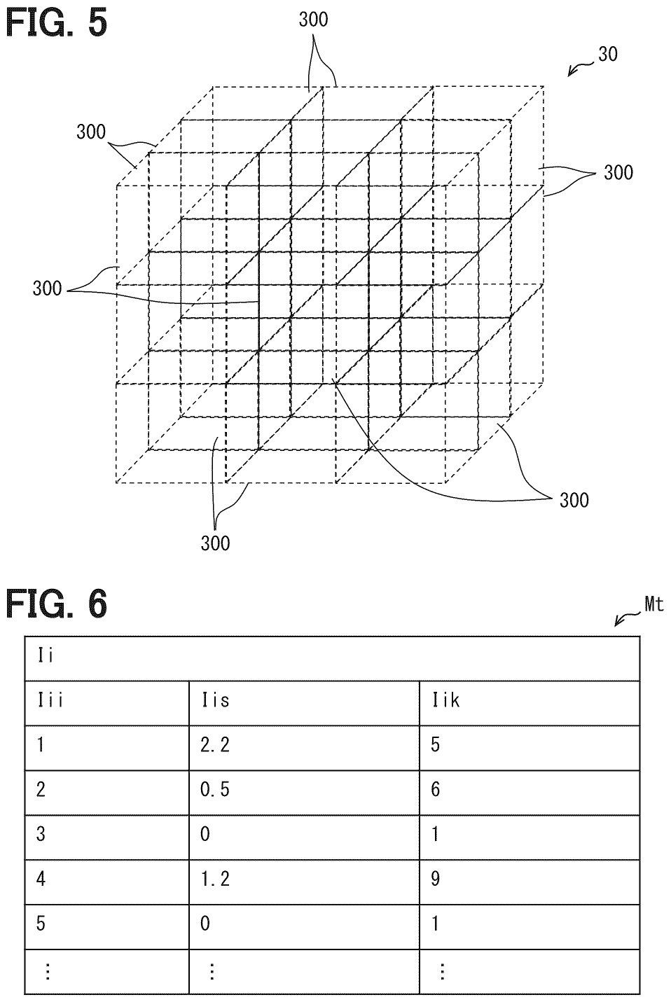

To the dynamic map Mt read in S101, three-dimensional voxels 300 resulting from division of the scan space 30 into multiple parts are set as illustrated in FIG. 5. In the dynamic map Mt, the individual voxels 300 are defined in a three-dimensional grid shape including cubes or cuboids and having six sides along three-dimensional absolute coordinate axes allocated to the scan space 30. However, in the vicinity of outermost edges of the scan space 30 determined depending on a viewing angle of the scanning device 3, the voxels 300 may be defined in partial shapes of a three-dimensional grid corresponding to parts of the cubes or cuboids. Such grid sizes of the individual voxels 300 are set to either the same size or multiple different sizes unless void spaces are generated between the individual voxels 300 in the scan space 30.

As illustrated in FIG. 6, in the dynamic map Mt, to each of the set voxels 300, identification information Ii for identifying a state of the scan space 30 is assigned in individually associated relation. The identification information Ii includes an index number lii as an identification ID associated with positional coordinates of each of the voxels 300. The identification information Ii includes distribution information Iis representing a distribution feature value of a mapping point group corresponding to an object in the scan space 30 in each of the voxels 300. The distribution information Iis may represent, for each of the voxels 300, the presence or absence of the point group in the scan space 30 with a value in excess of 0 representing the feature value of the point group distribution, such as, e.g., Mahalanobis distance, and a 0-value.

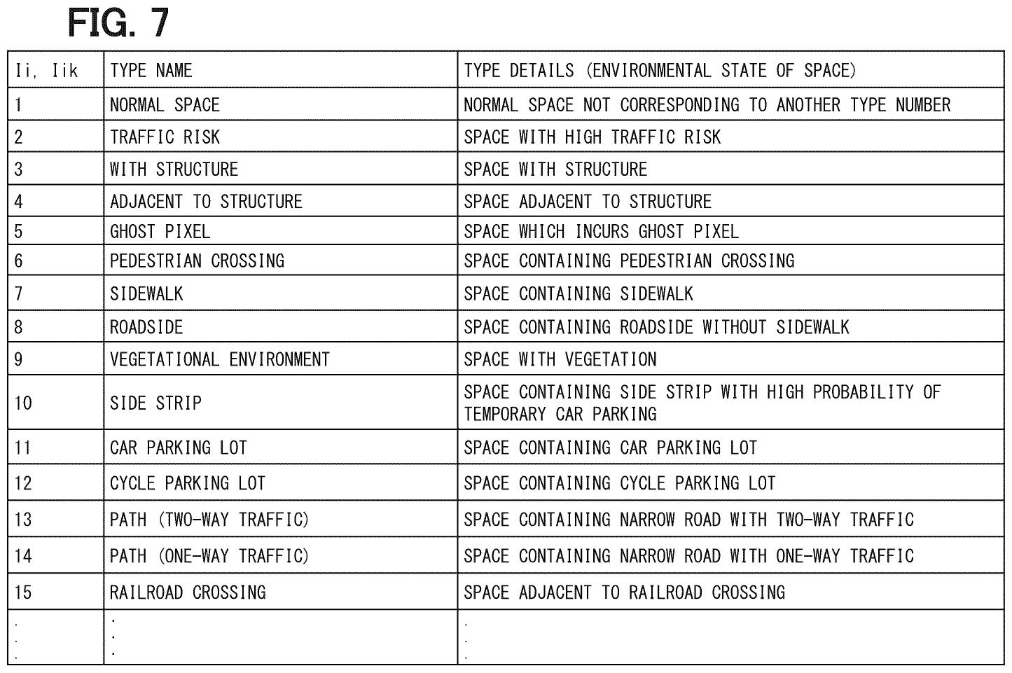

Additionally, in the dynamic map Mt, the identification information Ii includes type information Iik representing the type of the scan space 30 in each of the voxels 300. As illustrated in FIG. 6 and FIG. 7, the type information Iik represents, with a type number serving as the identification ID, a type featured to allow the environmental state of the scan space 30 to be identified.

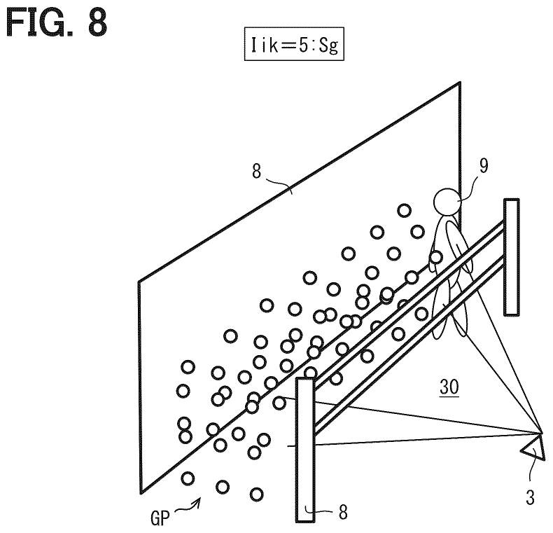

The type information Iik in the first embodiment mentioned herein includes at least one type number (number 5 in the example in FIG. 6 and FIG. 7) for identification of the environmental state in which a probability of occurrence of the erroneous scan point group due to the incurred ghost pixels in the scan data Dt becomes, e.g., in excess of a threshold or outside an allowable range above the threshold. It is to be noted herein that, to the environmental state in which the probability of occurrence of the erroneous scan point group is outside the allowable range, a front-rear recognition state Sg corresponds in which, as illustrated in FIG. 8, multiple stationary objects 8 are present to be spaced apart from each other in front-rear relation in a scan direction of the scanning device 3 in the scan space 30 as illustrated in FIG. 8, and accordingly erroneous recognition due to layered ghost pixels (GP in FIG. 8) is likely to occur. Note that FIG. 8 illustrates a guardrail and a vertical wall as examples of the multiple stationary objects 8 located in front-rear relation in the scan direction.

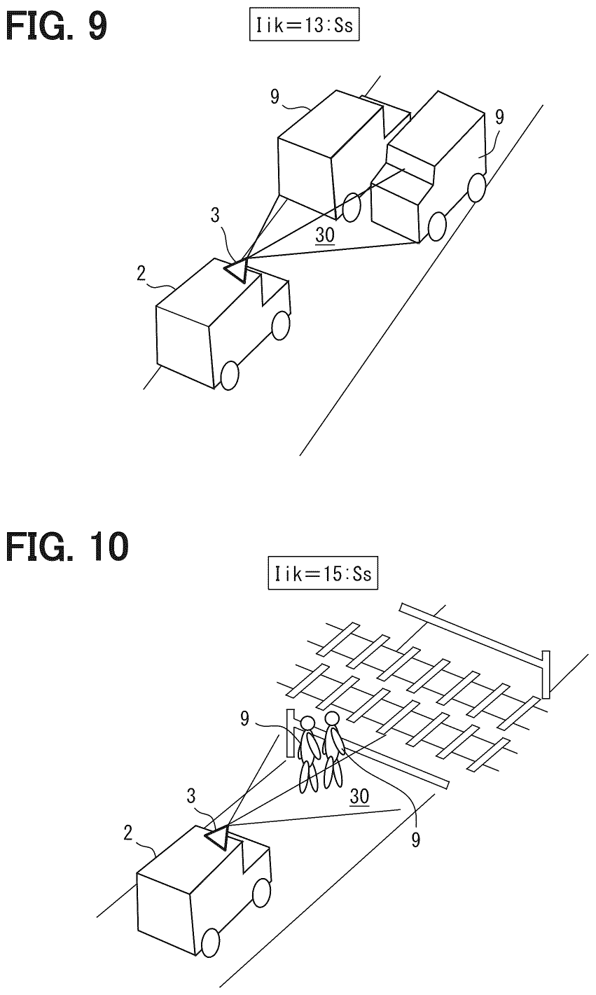

Additionally, the type information Iik in the first embodiment includes at least one type number (numbers 6 to 8 and 10 to 15 in the example in FIG. 6 and FIG. 7) for the identification of the environmental state that may possibly incur the ghost pixels or point group overlap in the scan data Dt. It is to be noted herein that, to the environmental state that may possibly incur the ghost pixels or point group overlap, the overlap recognition state Ss corresponds in which, as illustrated in FIG. 9 and FIG. 10, erroneous recognition is likely to occur due to a high possibility that multiple the target moving objects 9 are overlapped in the scan space 30 when viewed in the scan direction of the scanning device 3. Note that FIG. 9 illustrates other vehicles that pass through each other in different directions as examples of the multiple target moving objects 9 which are overlap with one another on a narrow path passable in both directions when viewed in the scan direction. Meanwhile, FIG. 10 illustrates multiple persons waiting at a railway crossing as examples of the multiple target moving objects 9 which are overlap with one another around the railway crossing when viewed in the scan direction.

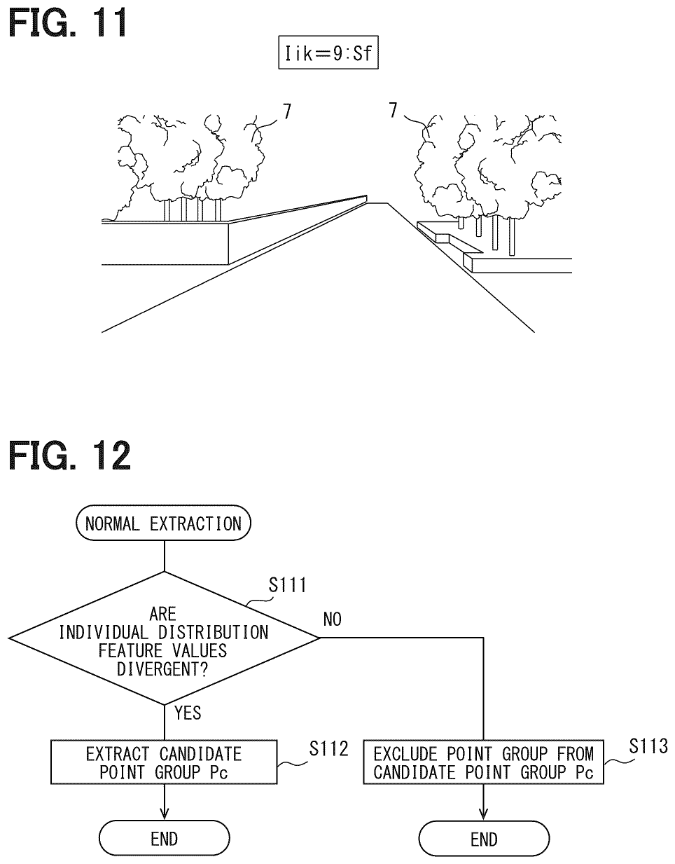

The type information Iik in the first embodiment further includes at least one type number (number 9 in the example in FIG. 6 and FIG. 7) for identification of an environmental state in which the object at the fixed-point position may possibly move in the scan data Dt. It to be noted herein that, to the environmental state in which the object at the fixed-point position may possibly move, as the vegetation 7 at the fixed-point position is moved in the wind as illustrated in FIG. 11, corresponds to the fixed-point recognition state Sf in which erroneous recognition as the target moving object 9 is likely to occur. The fixed-point recognition state Sf can also be said to be a state where erroneous recognition of the vegetation 7 at the fixed-point position as the target moving object 9 is likely to occur due to growth or cutting down thereof.

In S102 illustrated in FIG. 4, the matching block 100 may also resize the grid size of each of the voxels 300 set to the dynamic map Mt in the memory 10 to, e.g., a value optimized for recognition of the target moving objects 9 according to a driving scene based on, e.g., information acquired by the sensor system 4 and the communication system 5 or the like. At this time, the index number lii included in the identification information Ii is assigned again to each of the voxels 300 after the resizing. The distribution information Iis included in the identification information Ii is assigned again as a result of transformation of a distribution feature value in each of the voxels 300 before the resizing to a distribution feature value in each of the voxels 300 after the resizing. To the type information Iik included in the identification information Ii, a type number corresponding to an environmental state after the resizing is assigned again as a result of sorting or integration of the environmental state corresponding to the type number in each of the voxels 300 before the resizing as the environmental state in each of the voxels 300 after the resizing. Particularly in the case of the integration, a priority is set in advance for each of the types of the environmental states, and therefore the different environmental states in the multiple voxels 300 before the resizing may be integrated into the environmental state with a higher priority.

The setting of each of the voxels 300 to the dynamic map Mt and the assignment of the identification information Ii thereto, which has been described heretofore, may also be performed at a source of the latest map information. The setting of each of the voxels 300 to the dynamic map Mt and the assignment of the identification information Ii thereto may also be performed on the basis of the scan data Dt acquired by previous or current S101 according to a voxel setting flow other than the present recognition flow.

As illustrated in FIG. 4, in S103, the matching block 100 causes the scan data Dt acquired by S101 and the dynamic map Mt read by S102 to match. At this time, the matching block 100 may perform map matching with respect to the scan data Dt for each of the voxels 300 set to the dynamic map Mt on the basis of, e.g., NDT (Normal Distribution Transform) algorithm or the like.

In S104, the matching block 100 specifies, in the dynamic map Mt read by S102, the multiple voxels 300 corresponding to the individual position coordinates of the scan point group in the scan data Dt map-matched by S103. In S105, the matching block 100 acquires, from the dynamic map Mt read by S102, the identification information Ii assigned to each of the voxels 300 (hereinafter referred to as the specified voxels 300) specified by S104. In S106, the matching block 100 performs, for each of the specified voxels 300, candidate extraction processing according to at least type information Iik included in the identification information Ii acquired by S105 with respect to the scan point group in the scan data Dt map-matched by S103. The following will describe a specific example of the candidate extraction processing.

With respect to the specified voxel 300 having the type information Iik which is acquired by S105 and represents the type number other than those of Sg, Ss, and Sf, a normal extraction subroutine is executed such that the candidate extraction processing in S111 to S113 illustrated in FIG. 12 is performed in S106. Specifically, in S111, the matching block 100 compares the distribution feature value represented by the distribution information Iis included in the identification information Ii acquired by S105 to the distribution feature value inside each of the specified voxels 300 in the scan point group in the scan data Dt map-matched by S103. As a result, when it is determined that the individual distribution feature values are divergent, the normal extraction subroutine moves to S112. The determination of the divergence between the individual distribution feature values may be made when a deviation between these distribution feature values is in excess of or not less than a threshold, and the threshold may be defined as a numerical value of not less than 0.

In S112, the matching block 100 extracts, as a candidate point group Pc, the point group inside the specified voxel 300 from the scan point group in the scan data Dt map-matched by S103. Then, the matching block 100 in S112 stores list data Dc of the extracted candidate point group Pc in the memory 10. Thus, the normal extraction subroutine is ended.

Meanwhile, when it is determined in S111 that the individual distribution feature values are not divergent, the normal extraction subroutine moves to S113. In S113, the matching block 100 recognizes, in the scan point group in the scan data Dt map-matched by S103, the point group inside the specified voxel 300 as a mapping point group of the object at the fixed-point position and excludes the point group inside the specified voxel 300 from the candidate point group Pc to be stored in the memory 10. Thus, the normal extraction subroutine is ended.

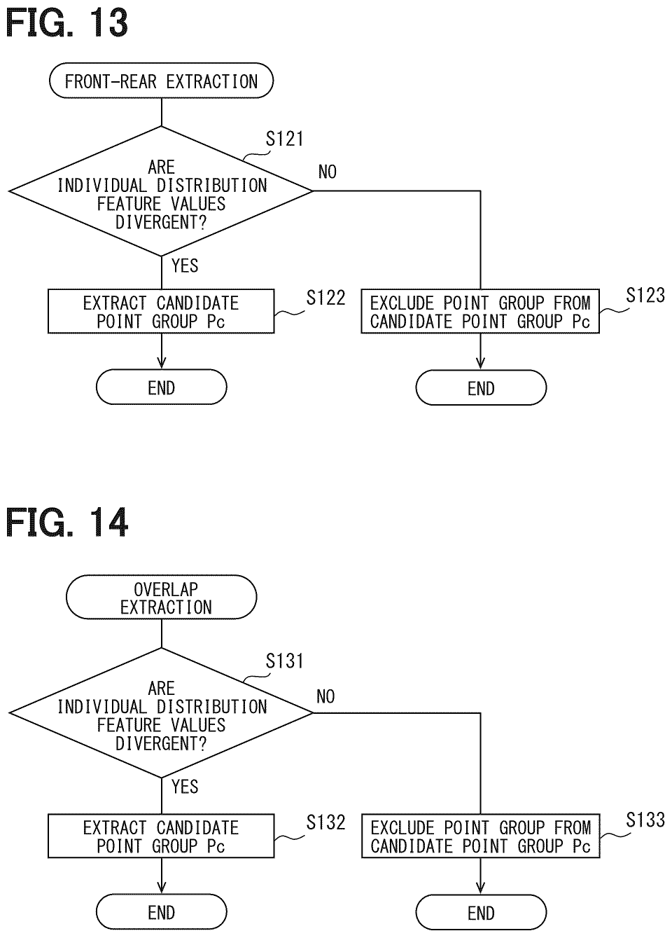

With respect to the specified voxel 300 having the type information Iik which is acquired by S105 and represents the type number of the front-rear recognition state Sg, a front-rear extraction subroutine is executed such that the candidate extraction processing in S121 to S123 illustrated in FIG. 13 is executed in S106. Specifically, in S121, the matching block 100 compares the distribution feature value represented by the distribution information Iis included in the identification information Ii acquired by S105 to the distribution feature value inside the specified voxel 300 of the scan point group in the scan data Dt map-matched by S103. As a result, when it is determined that the individual distribution feature values are divergent, the front-rear extraction subroutine moves to S122. It is to be noted herein that the determination of the divergence between the individual distribution feature values is based on the normal extraction subroutine. However, the threshold serving as a criterion for the divergence determination in the front-rear extraction subroutine may also be adjusted so as to tolerate up to a divergence larger than a threshold in the normal recognition subroutine.

In S122, the matching block 100 extracts, as a candidate point group Pc, the point group inside the specified voxel 300 from the scan point group in the scan data Dt map-matched by S103. Then, the matching block 100 in S122 stores the list data Dc of the extracted candidate point group Pc in the memory 10. Thus, the front-rear extraction subroutine is ended.

Meanwhile, when it is determined in S121 that the individual distribution feature values are not divergent, the front-rear extraction subroutine moves to S123. In S123, the matching block 100 recognizes, in the scan point group in the scan data Dt map-matched by S103, the point group inside the specified voxel 300 as the mapping point group of the object at the fixed-point position and excludes the point group inside the specified voxel 300 from the candidate point group Pc to be stored in the memory 10. Thus, the front-rear extraction subroutine is ended.

With respect to the specified voxel 300 having the type information Iik which is acquired by S105 and represents the type number of the overlap recognition state Ss, an overlap extraction subroutine is executed such that the candidate extraction processing in S131 to S133 illustrated in FIG. 14 is performed in S106. Specifically, in S131, the matching block 100 compares the distribution feature value represented by the distribution information Iis included in the identification information Ii acquired by S105 to the distribution feature value inside the specified voxel 300 in the scan point group in the scan data Dt map-matched by S103. As a result, when it is determined that the distribution feature values are divergent, the overlap extraction subroutine moves to S132. It is to be noted herein that the determination of the divergence between the individual distribution feature values is based on the normal extraction subroutine. However, the threshold serving as a criterion for the divergence determination in the overlap extraction subroutine may also be adjusted so as to tolerate up to a divergence larger than a threshold in the normal recognition subroutine.

In S132, the matching block 100 extracts, as a candidate point group Pc, the point group inside the specified voxel 300 from the scan point group in the scan data Dt map-matched by S103. Accordingly, the matching block 100 in S132 stores the list data Dc of the extracted candidate point group Pc in the memory 10. Thus, the overlap subroutine is ended.

Meanwhile, when it is determined in S131 that the distribution feature values are not divergent, the overlap extraction subroutine moves to S133. In S133, the matching block 100 recognizes, in the scan point group in the scan data Dt map-matched by S103, the point group inside the specified voxel 300 as the mapping point group of the object at the fixed-point position and excludes the point group inside the specified voxel 300 from the candidate point group Pc to be stored in the memory 10. Thus, the overlap subroutine is ended.

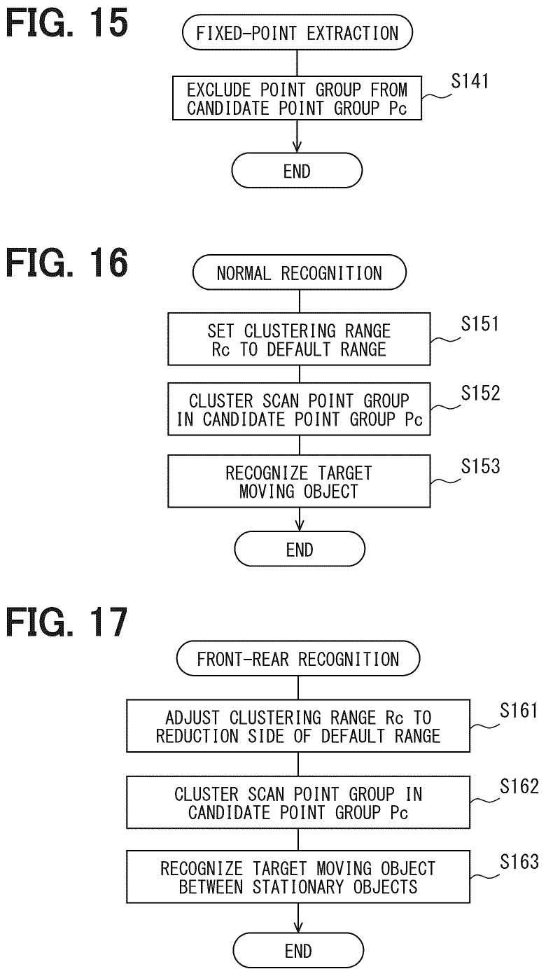

With respect to the specified voxel 300 having the type information Iik which is acquired by S105 and represents the type number of the fixed-point recognition state Sf, a fixed-point extraction subroutine is executed such that the candidate extraction processing in S141 illustrated in FIG. 15 is performed in S106. Specifically, in S141, the matching block 100 recognizes, in the scan point group in the scan data Dt map-matched by S103, the point group inside the specified voxel 300 as the mapping point group of an object which may move at the fixed-point position and excludes the point group inside the specified voxel 300 from the candidate point group Pc to be stored in the memory 10. Thus, the fixed-point extraction subroutine is ended.

As illustrated in FIG. 4, in S107, the clustering block 110 performs, on the candidate point group Pc stored in the memory 10 through the extraction in S106, recognition processing by clustering according particularly to the type information Iik included in the identification information Ii acquired by S105 for each of the specified voxels 300. The following will describe a specific example of the recognition processing.

With respect to each of the specified voxels 300 having the type information Iik acquired by S105 which represents the type number other than those of Sg, Ss, and Sf, the normal recognition subroutine is executed such that the candidate extraction processing in S151 to S153 illustrated in FIG. 16 is performed in S107. Specifically, in S151, the clustering block 110 sets, for the scan data Dt map-matched by S103, a clustering range Rc in which the candidate point group Pc inside the specified voxel 300 is to be clustered to a default range. The clustering range Rc in which the candidate point group Pc is to be clustered is defined as a range at the same distance in each of dimensional directions along the three-dimensional absolute coordinate axes allocated to the scan space 30. Accordingly, the default range of the clustering range Rc is defined as a fixed range (e.g., 1 m) required to retrieve and appropriately recognize the target moving object 9 in the environmental states other than the states Sg, Ss, and Sf. However, the default range of the clustering range Rc may also be adjusted to a variable range which is enlarged as the distance to the specified voxel 300 increases.

In S152, the clustering block 110 clusters, in the candidate point group Pc inside the specified voxel 300 in the scan data Dt map-matched by S103, the scan point group having an Euclidean distance falling within the clustering range Rc set by S151. Accordingly, in S153, the clustering block 110 recognizes the target moving object 9 by being based on the clustered scan point group. It is to be noted herein that the clustering block 110 in S153 may also filter the clustered scan point group in order to recognize the target moving object 9 in putatively distinct relation to the ghost pixels resulting from, e.g., sensor noise or the like. An estimation model used for the filtering at this time may be a rule-based model or an AI model. Particularly when the rule-based model is used, the filtering may also be carried out on the basis of a determination index such as, e.g., the number of clustering points, a clustering size, or a spatial position of the scan point group clustered by S152. Thus, the normal recognition subroutine is ended.

With respect to the specified voxel 300 having the type information Iik which is acquired by S105 and represents the type number of the front-rear recognition state Sg, a front-rear recognition subroutine is executed such that the recognition processing in S161 to S163 illustrated in FIG. 17 is performed in S107. Specifically, in S161, the clustering block 110 adjusts the clustering range Rc for the scan data Dt map-matched by S103 to a reduction side (e.g., 0.2 m or less) of the default range for the normal recognition subroutine. At this time, when the candidate point group Pc is present correspondingly to the space between the multiple stationary objects 8 arranged in front-rear relation in the scan space 30 inside the specified voxel 300, the range Rc in which the candidate point group Pc between the stationary objects 8 is clustered is reduced in size to be smaller than the default range through the adjustment in S161.

In S162, the clustering block 110 clusters, in the candidate point group Pc inside the specified voxel 300 in the scan data Dt map-matched by S103, the scan point group having an Euclidean distance falling within the clustering range Rc set by S161. Accordingly, in S163, the clustering block 110 recognizes the target moving object 9 by being based on the clustered scan point group. At this time, when the scan point group corresponding to the space between the multiple stationary objects 8 arranged in front-rear relation in the scan space 30 inside the specified voxel 300 is clustered, the target moving object 9 (see FIG. 8) between the stationary objects 8 can be recognized. Accordingly, in S163 also, in order to recognize the target moving object 9, the same filtering as that in S153 may also be carried out. However, in S163 of the front-rear recognition subroutine, to particularly discriminate the target moving object 9 between the stationary objects 8 from the ghost pixels with the rule-based model, the determination threshold for the determination index mentioned above may also be adjusted to a side which increases a probability of exclusion of the ghost pixels to a value larger than a default value in the normal recognition subroutine. Thus, the front-rear recognition subroutine is ended.

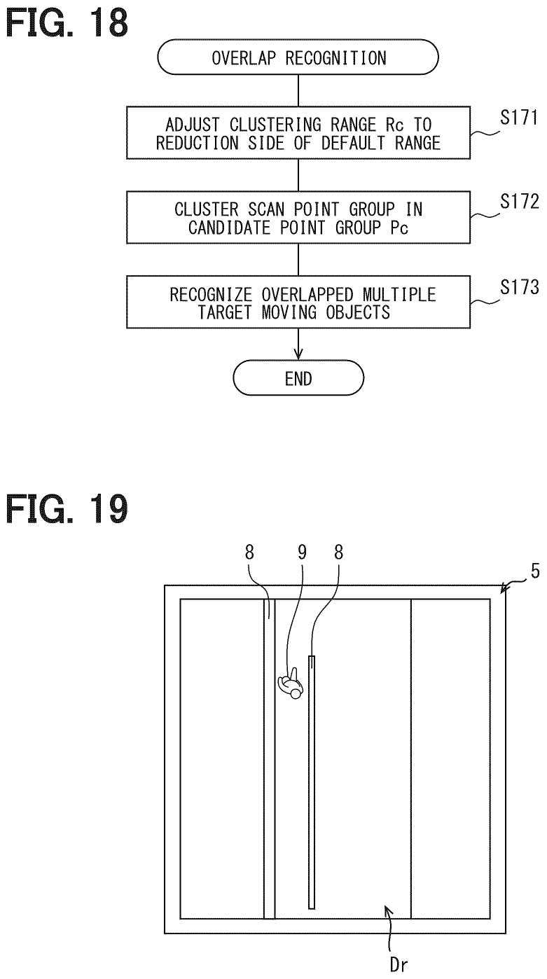

With respect to the specified voxel 300 having the type information Iik which is acquired in S105 and represents the type number of the overlap recognition state Ss, an overlap recognition subroutine is executed such that the recognition processing in S171 to S173 illustrated in FIG. 18 is performed in S107. Specifically, in S171, the clustering block 110 adjusts the clustering range Rc for the scan data Dt map-matched by S103 to a reduction side (e.g., 0.2 m or less) of the default range. At this time, in the scan space 30 inside the specified voxel 300, when the candidate point groups Pc corresponding to the multiple individual target moving objects 9 are overlap with one another when viewed in the scan direction of the scanning device 3, the range Rc in which each of the candidate point groups Pc for the target moving objects 9 is clustered is reduced to be smaller than the default range through the adjustment in S161.

In S172, the clustering block 110 clusters, in the candidate point group Pc inside the specified voxel 300 in the scan data Dt map-matched by S103, the scan point group having an Euclidean distance falling within the clustering range Rc set by S171. Accordingly, in S173, the clustering block 110 recognizes the target moving object 9 by being based on the clustered scan point group. At this time, in the scan space 30 in the specified voxel 300, when the scan point groups individually corresponding to the multiple target moving objects 9 are clustered to be overlap with one another when viewed in the scan direction of the scanning device 3, it is possible to separately recognize the target moving objects 9 (see FIG. 9 and FIG. 10). Accordingly, in S173 also, in order to recognize the target moving object 9, the same filtering as that in S153 may also be carried out. However, in S173 of the overlap recognition subroutine, particularly to discriminate the multiple target moving objects 9 which are overlap with one another in the scan direction from the ghost pixels with the rule-based model, the determination threshold for the determination index mentioned above may also be adjusted to a side which increases the probability of the exclusion of the ghost pixels to a value larger than the default value in the normal recognition subroutine. Thus, the overlap recognition subroutine is ended.

Note that, with respect to the specified voxel 300 having the type information Iik which is acquired by S105 and represents the type number of the fixed-point recognition state Sf, the candidate point group Pc is not extracted by the fixed-point extraction subroutine in S106. Consequently, with respect to the specified voxel 300 in the fixed-point recognition state Sf, the recognition processing in S107 is not performed.

As illustrated in FIG. 4, in S108, the clustering block 110 generates recognition data Dr such that the recognition data Dr represents a result of performing recognition processing on the target moving object 9 by clustering in S107. Then, in S109, the clustering block 110 stores the generated recognition data Dr in the memory 10. At this time, to allow the recognition data Dr generated or further stored to be displayed by, e.g., the information presentation system 6 in the host moving object 2 as illustrated in FIG. 19, the clustering block 110 may also control the display. Alternatively, to allow the recognition data Dr generated or further stored to be transmitted by the communication system 5 to the outside (such as, e.g., the external center or another vehicle) of the host moving object 2, the clustering block 110 may also control the transmission. Thus, the current execution of the recognition flow is ended. Note that the recognition data Dr stored in the memory 10 is used to control the driving of the host moving object 2.

The following will describe effects of the first embodiment.

In the first embodiment, the recognition data Dr resulting from the recognition of the target moving object 9 between the multiple stationary objects 8 which are spaced apart from each other in the front-rear relation in the scan direction of the scanning device 3 in the scan space 30 is generated. At this time, according to the first embodiment, by being based on the identification information Ii for identifying the state of the scan space 30 in each of the multiple voxels 300 into which the scan space 30 is divided in the dynamic map Mt, it is possible to exclude the erroneous scan point group from the scan point groups which are clustered correspondingly to the spaces between the multiple stationary objects 8 in the scan data Dt. Therefore, it is possible to recognize the target moving object 9 that has entered any of the spaces between the multiple stationary objects 8 with high accuracy.

According to the first embodiment, the clustering range Rc in which each of the scan point groups corresponding to the spaces between the multiple stationary objects 8 is to be clustered in the scan data Dt is adjusted to the reduction side on the basis of the identification information Ii. Consequently, it is possible to perform appropriate clustering by excluding the erroneous scan point group with a low point group density, which is among the scan point groups corresponding to the spaces between the multiple stationary objects 8, from the clustering range Rc, while allowing the scan point group of the target moving object 9 with a high point group density to fall within the clustering range Rc. Therefore, it is possible to ensure reliability for high-accuracy recognition of the target moving object 9 that has entered any of the spaces between the multiple stationary objects 8.

According to the first embodiment, the clustering range Rc for each of the scan point groups between the individual stationary objects 8 is adjusted particularly on the basis of the type information Iik representing the type of the scan space 30, which is included in the identification information Ii. Consequently, when the type represented by the type information Iik in the dynamic map Mt is the type having a high possibility of causing the erroneous scan point group between the stationary objects 8 in the scan direction, through adjustment to the reduction side according to the possibility, it is possible to facilitate the exclusion of the erroneous scan point group from the clustering range Rc. Therefore, it is possible to implement the clustering focused on the scan point group of the target moving object 9 that has entered any of the spaces between the multiple stationary objects 8 and increase the reliability on the high-accuracy recognition of the target moving object 9.

In the first embodiment, the recognition data resulting from the recognition of the multiple target moving objects 9 which are overlap with one another in the scan direction when viewed from the scanning device 3 in the scan space 30. At this time, according to the first embodiment, by being based on the identification information Ii for identifying the state of the scan space 30 in each of the multiple voxels 300 into which the scan space 30 is divided in the dynamic map Mt, the erroneous scan point group can be excluded from the scan point groups clustered correspondingly to the spaces between the multiple target moving objects 9 in the scan data Dt. Therefore, it is possible to recognize each of the target moving objects 9 which are overlap with one another when viewed in the scan direction with high accuracy.

According to the first embodiment, the clustering range Rc in which each of the scan point groups corresponding to the individual target moving objects 9 is clustered in the scan data Dt is adjusted to the reduction side on the basis of the identification information Ii. Consequently, it is possible to perform the appropriate clustering by excluding the erroneous scan point group with the low point group density, which is among the scan point groups corresponding to the spaces between the multiple target moving objects 9, from the clustering range Rc, while allowing the scan point groups of the individual target moving objects 9 with the high point group densities to fall within the respective clustering ranges Rc. Therefore, it is possible to ensure reliability for the high-accuracy recognition of the individual target moving objects 9 which are overlap with one another when viewed in the scan direction.

According to the first embodiment, each of the clustering ranges Rc for the scan point groups of the individual target moving objects 9 is adjusted particularly on the basis of the type information Iik representing the type of the scan space 30 which is included in the identification information Ii. Accordingly, when the type represented by the type information Iik in the dynamic map Mt is the type having a high possibility of causing overlap of the target moving objects 9 when viewed in the scan direction, the adjustment to the reduction side according to the possibility facilitates the exclusion of the erroneous scan point group from the clustering range Rc. In addition, such adjustment to the reduction side according to the possibility allows the scan point groups of the individual target moving objects 9 to easily fall within the respective clustering ranges Rc. Therefore, it is possible to increase the reliability on the high-accuracy recognition of each of the target moving objects 9 which are overlap with one another when viewed in the scan direction.

According to the first embodiment, the candidate point group Pc serving as the scan point group to be clustered is extracted particularly on the basis of the type information Iik included in the identification information Ii and representing the type of the scan space 30. Accordingly, when the type represented by the type information Iik in the dynamic map Mt is the type involving a possibility of movement of the object at the fixed-point position such as, e.g., a vegetational environment, the scan point group may be excluded from the candidate point group Pc to be clustered. Therefore, it is possible to suppress a situation in which the accuracy of the recognition of the target moving objects 9 is degraded by the clustering of the scan point group corresponding to the object moving at the fixed-point position.

According to the first embodiment, the candidate point group Pc serving as the scan point group to be clustered is extracted particularly on the basis of the distribution information Iis included in the identification information Ii and representing the feature value of the point group distribution in the scan space 30. Accordingly, when the feature value represented by the distribution information Iis in the dynamic map Mt is divergent from the feature value of the point group distribution in the scan data Dt, the candidate point group Pc of the specified voxel 300 corresponding to the point group distribution may be subjected to clustering. Therefore, it is possible to implement clustering focused on the scan point group of the target moving object 9 in which the dynamic map Mt has no matching point group and increase the reliability on the high-accuracy recognition of the target moving objects 9.

### Second Embodiment

The second embodiment is a modification of the first embodiment.

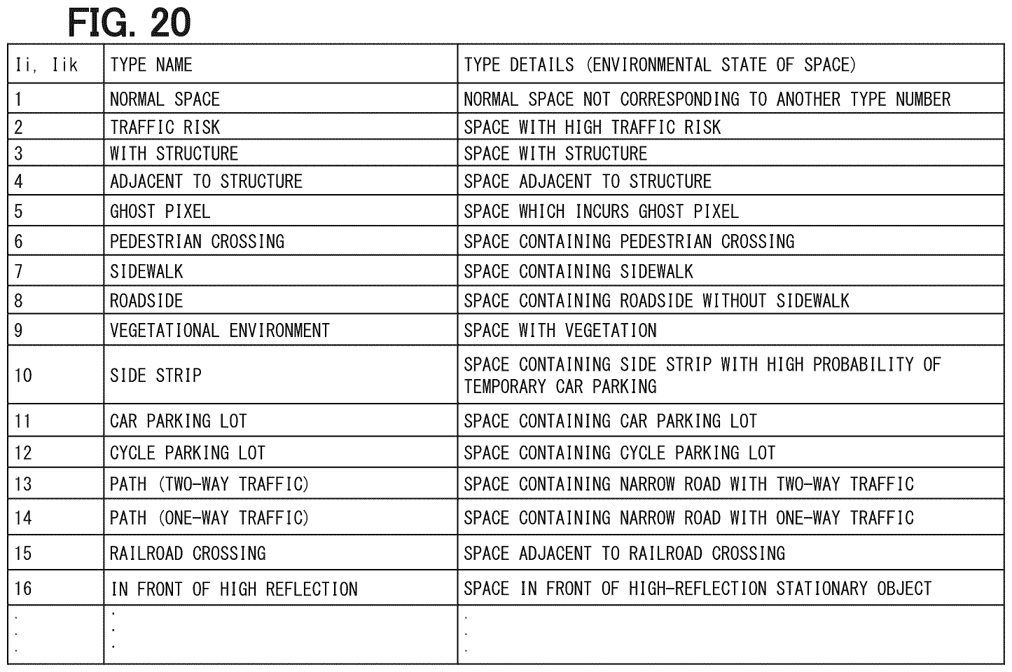

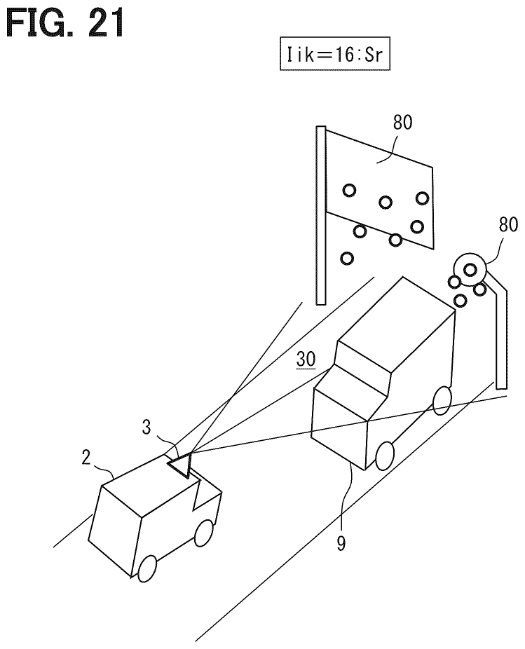

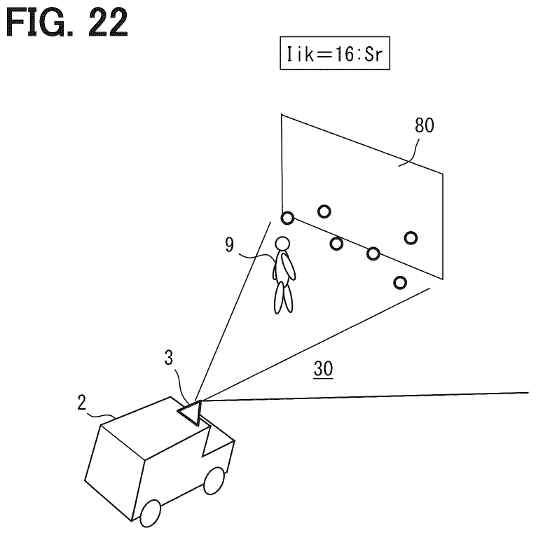

The type information Iik in the dynamic map Mt read by S101 in a recognition flow in the second embodiment includes at least one type number (number 16 in the example in FIG. 20) for identifying the environmental state which may incur the ghost pixels in the scan data Dt, as illustrated in FIG. 20. To the environmental state which may incur the ghost pixels mentioned herein, a high-reflection recognition state Sr where, due to the presence of a high-reflection stationary object 80 having a reflectance to a scan beam from the scanning device 3 which is as high as outside an allowable range in the scan space 30 as illustrated in FIG. 21 and FIG. 22, erroneous recognition is like to occur in front of the high-reflection stationary object 80 in the scan direction corresponds. Accordingly, the reflectance on a high reflection side of the allowable range of the reflectance in which the erroneous recognition due to the ghost pixels presumably does not occur in front of the high-reflection stationary object 80 is defined as the reflectance outside the allowable range. Note that FIG. 21 illustrates an example of a sign and a mirror each as the high-reflection stationary object 80. Meanwhile, FIG. 22 illustrates a window glass of a building as the high-reflection stationary object 80.

In such a recognition flow in the second embodiment, with respect to the specified voxel 300 having the type information Iik which is acquired by S105 and represents the type number other than those of the states Sg, Ss, Sf, and Sr, the same normal extraction subroutine as that in the first embodiment is executed in S106. In the recognition flow in the second embodiment, with respect to the specified voxel 300 having the type information Iik representing the type number of the front-rear recognition state Sg, the same front-rear extraction subroutine as that in the first embodiment is executed in S106. In the recognition flow in the second embodiment, with respect to the specified voxel 300 having the type information Iik representing the type number of the overlap recognition state Ss, the same overlap extraction subroutine as that in the first embodiment is executed in S106. In the recognition flow in the second embodiment, with respect to the specified voxel 300 having the type information Iik representing the type number of the fixed-point recognition state Sf, the same fixed-point extraction subroutine as that in the first embodiment is executed in S106.

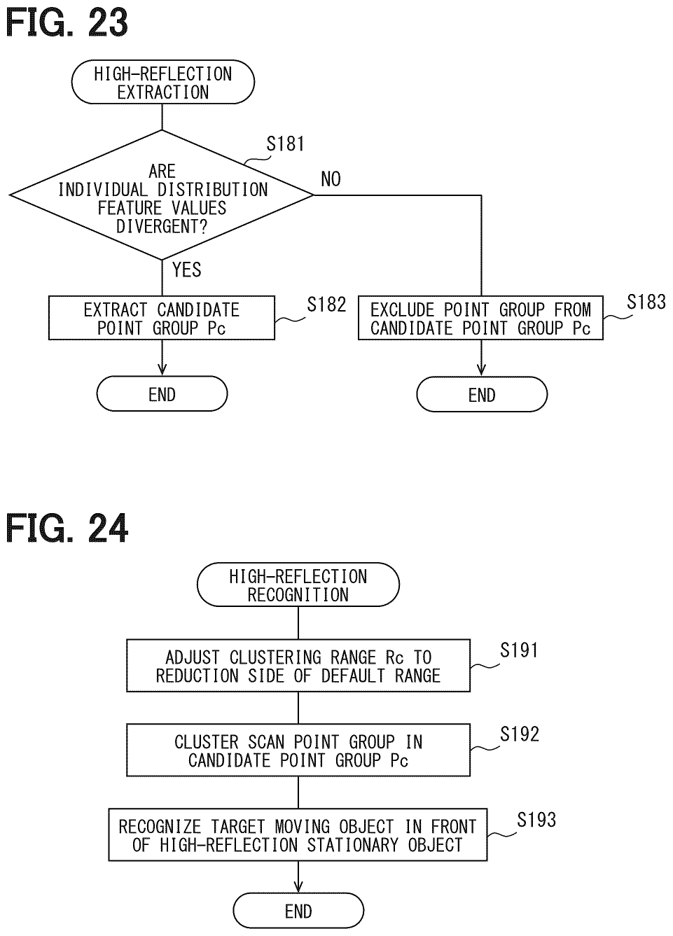

Furthermore, in the recognition flow in the second embodiment, with respect to the specified voxel 300 having the type information Iik representing the type number of the high-reflection recognition state Sr, a high-reflection extraction subroutine is executed such that the candidate extraction processing in S181 to S183 illustrated in FIG. 23 is performed in S106. Specifically, in S181, the matching block 100 compares the distribution feature value represented by the distribution information Iis which is included in the identification information Ii acquired by S105 to the distribution feature value inside the specified voxel 300 in the scan point group in the scan data Dt map-matched by S103. As a result, when it is determined that the individual distribution feature values are divergent, the high-reflection extraction subroutine moves to S182. The determination of the divergence between the distribution feature values is based herein on the normal extraction subroutine described in the first embodiment. However, the threshold serving as a criterion for the divergence determination in the high-reflection extraction subroutine may also be adjusted so as to tolerate up to a divergence larger than a threshold in the normal recognition subroutine.

After S106, in the recognition flow in the second embodiment, with respect to the specified voxel 300 having the type information Iik which is acquired by S105 and represents the type number other than those of the states Sg, Ss, Sf, and Sr, the same normal recognition subroutine as that in the first embodiment is executed in S107. In the recognition flow in the second embodiment, with respect to the specified voxel 300 having the type information Iik representing the type number of the front-rear recognition state Sg, the same front-rear recognition subroutine as that in the first embodiment is executed in S107. In the recognition flow in the second embodiment, with respect to the specified voxel 300 having the type information Iik representing the type number of the overlap recognition state Ss, the same overlap recognition subroutine as that in the first embodiment is executed in S107.

Furthermore, in the recognition flow in the second embodiment, with respect to the specified voxel 300 having the type information Iik representing the type number of the high-reflection recognition state Sr, the high-reflection recognition subroutine is executed such that the recognition processing in S191 to S193 illustrated in FIG. 24 is performed in S107. Specifically, in S191, the clustering block 110 adjusts the clustering range Rc for the scan data Dt map-matched by S103 to the reduction side (e.g., 0.2 meter or less) of the default range. At this time, when there is the candidate point group Pc corresponding to an area in front of the high-reflection stationary object 80 in the scan space 30 inside the specified voxel 300, the range Rc in which the candidate point group Pc in the front area is clustered is reduced in size from the default range through the adjustment in S191.

In S192, the clustering block 110 clusters, in the candidate point group Pc inside the specified voxel 300 in the scan data Dt map-matched by S103, the scan point group having an Euclidean distance falling within the clustering range Rc set by S191. Accordingly, in S193, the clustering block 110 recognizes the target moving object 9 by being based on the clustered scan point group. At this time, in the scan space 30 inside the specified voxel 300, when the scan point group corresponding to the area in front of the high-reflection stationary object 80 is clustered, it is possible to recognize the target moving object 9 (see FIG. 21 and FIG. 22) in the front area. Accordingly, in S193 also, in order to recognize the target moving object 9, the same filtering as that in S153 described in the first embodiment may also be carried out. Note that, in S193 of the high-reflection recognition subroutine, to discriminate the target moving object 9 in the area in front of the high-reflection stationary object 80 from the ghost pixels with the rule-based model, a determination threshold for the determination index described in the first embodiment may also be adjusted to a value which increases a probability of exclusion of the ghost pixels relative to a default value in the normal recognition subroutine. Thus, the high-reflection recognition subroutine is ended.

Thus, in the second embodiment, the recognition data Dr resulting from recognition of the target moving object 9 in front of the high-reflection stationary object 80 having the reflectance to the scan beam from the scanning device 3 which is as high as outside the allowable range when viewed in the scan direction is generated. At this time, according to the second embodiment, by being based on the identification information Ii for identifying the state of the scan space 30 in each of the multiple voxels 300 into which the scan space 30 is divided in the dynamic map Mt, it is possible to exclude the erroneous scan point group from the scan point groups clustered correspondingly to a space in front of the high-reflection stationary object 80 in the scan data Dt. Therefore, it is possible to recognize the target moving object 9 that has entered a space in front of the high-reflection stationary object 80 with high accuracy.

According to the second embodiment, in the scan data Dt, the clustering range Rc in which the scan point groups corresponding to the space in front of the high-reflection stationary object 80 are clustered is adjusted to the reduction side on the basis of the identification information Ii. Consequently, it is possible to perform appropriate clustering by excluding, among the scan point groups corresponding to the space in front of the high-reflection stationary object 80, the erroneous scan point group with a lower point group density from the clustering range Rc, while allowing the scan point group of the target moving object 9 with a higher point group density to fall within the clustering range Rc. Therefore, it is possible to ensure reliability on high-accuracy recognition of the target moving object 9 that has entered the space in front of the high-reflection stationary object 80.

According to the second embodiment, the clustering range Rc for the scan point groups in front of the high-reflection stationary object 80 is adjusted particularly on the basis of the type information Iik included in the identification information Ii and representing the type of the scan space 30. As a result, when the type represented by the type information Iik in the dynamic map Mt is a type having a high possibility of causing the erroneous scan point group in front of the high-reflection stationary object 80, it is possible to easily exclude the erroneous scan point group from the clustering range Rc through the adjustment to the reduction side according to the possibility. Therefore, it is possible to implement clustering focused on the scan point group of the target moving object 9 that has entered the space in front of the high-reflection stationary object 80 and increase the reliability on the high-accuracy recognition of the target moving object 9.

### Other Embodiments

While the description has been given heretofore of the multiple embodiments, the present disclosure is not to be construed as being limited to these embodiments, and is applicable to various embodiments within a scope not departing from the gist of the present disclosure.

In a modification, a dedicated computer included in the recognition system 1 may also have at least one of a digital circuit and an analog circuit as a processor. The digital circuit mentioned herein is at least one type among, e.g., an ASIC (Application Specific Integrated Circuit), a FPGA (Field Programmable Gate Array), a SOC (System on a Chip), a PGA (Programmable Gate Array), a CPLD (Complex Programmable Logic Device), and the like. Such a digital circuit may also have a memory storing therein a program.

In S106 in the modification, with respect to an environmental state which corresponds to either one of the front-rear recognition state Sg and the overlap recognition state Ss and in which either one of the front-rear extraction subroutine and the overlap extraction subroutine is not executed, the normal extraction subroutine may also be executed. In this case, in S107, with respect to the environmental state which corresponds to either one of the front-rear recognition state Sg and the overlap recognition state Ss and in which either one of the front-rear recognition subroutine and an overlap recognition subroutine is not executed, the normal recognition subroutine may be executed appropriately.

In S106 in the modification, with respect to the fixed-point recognition state Sf which corresponds to the fixed-point extraction subroutine and in which the fixed-point extraction subroutine is not executed, the normal extraction subroutine may also be executed. In this case, in S107, the normal recognition subroutine may be executed with respect to the fixed-point recognition state Sf.

A host moving object to which the recognition system 1 is applied in the modification may also be, e.g., a traveling robot capable of luggage transformation, information collection, or the like by, e.g., autonomous traveling or remote traveling. As a recognition apparatus configured to be mountable on the host moving object and having the at least one processor 12 and the at least one memory 10, the embodiment and modification each described above may also be implemented in a mode of a processing circuit (such as, e.g., a processing ECU) or a mode of a semiconductor device (such as, e.g., a semiconductor chip) besides the mode described heretofore.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A recognition system comprising:
a computer-readable non-transitory storage medium; and
a processor, by executing a program stored in the computer-readable non-transitory storage, configured to recognize, in a scan space, a target moving object that is movable in the scan space by scanning the target moving object using a scanning device mounted on a host moving object,
wherein the processor is configured to:
acquire three-dimensional scan data representing a scan point group generated by scanning of the scan space;
read, from a storage medium, a three-dimensional dynamic map representing a mapping point group generated by mapping of an object present in the scan space; and
cluster the scan point group based on identification information for identifying a state of the scan space in each of multiple three-dimensional voxels into which the scan space is divided in the three-dimensional dynamic map and generate recognition data by recognizing the target moving object present between multiple stationary objects which are spaced apart from each other in front-rear relation along a scan direction of the scanning device in the scan space.

2. The recognition system according to claim 1, wherein,
when the processor generates the recognition data, the processor adjusts, based on the identification information, a clustering range in which the scan point group corresponding to a space between the multiple stationary objects is clustered in the three-dimensional scan data to be reduced compared with a default range.

3. The recognition system according to claim 1, wherein
the processor clusters the scan point group based on the identification information and generates the recognition data, which indicates multiple target moving objects overlapped with one another in the scan space when viewed in the scan direction.

4. A recognition system comprising:
a computer-readable non-transitory storage medium; and
a processor, by executing a program stored in the computer-readable non-transitory storage, configured to recognize, in a scan space, target moving objects that are movable in the scan space by scanning the target moving objects using a scanning device mounted on a host moving object,
wherein the processor is configured to:
acquire three-dimensional scan data representing a scan point group generated by scanning of the scan space;
read, from a storage medium, a three-dimensional dynamic map representing a mapping point group generated by mapping of an object present in the scan space; and
cluster the scan point group based on identification information for identifying a state of the scan space in each of multiple three-dimensional voxels into which the scan space is divided in the three-dimensional dynamic map and generate recognition data by recognizing the target moving objects, which are overlapped with one another in the scan space when viewed in a scan direction of the scanning device.

5. The recognition system according to claim 4, wherein,
when the processor generates the recognition data, the processor adjusts based on the identification information, a clustering range in which the scan point group corresponding to each of the target moving objects is clustered in the three-dimensional scan data to be reduced compared with a default range.

6. The recognition system according to claim 2, wherein,
when the processor generates the recognition data, the processor adjusts the clustering range based on type information, which is included in the identification information and represents a type of the scan space.

7. The recognition system according to claim 1, wherein
the processor is further configured to cluster the scan point group based on the identification information and generate the recognition data by recognizing the target moving object present in front of a high-reflection stationary object in the scan space when viewed in the scan direction, and
a reflectance of the high-reflection stationary object to a scan beam emitted from the scanning device is higher than an acceptable range.

8. The recognition system according to claim 7, wherein,
when the processor generates the recognition data, the processor adjusts, based on the identification information, a clustering range in which the scan point group corresponding to a space in front of the high-reflection stationary object is clustered in the three-dimensional scan data to be reduced compared with a default range.

9. The recognition system according to claim 8, wherein,
when the processor generates the recognition data, the processor adjusts the clustering range based on type information, which is included in the identification information and represents a type of the scan space.

10. The recognition system according to claim 1, wherein,
when the processor generates the recognition data, the processor extracts the scan point group to be clustered based on type information, which is included in the identification information and represents a type of the scan space.

11. The recognition system according to claim 1, wherein,
when the processor generates the recognition data, the processor extracts the scan point group to be clustered based on distribution information, which is included in the identification information and represents a feature value of point group distribution in the scan space.

12. The recognition system according to claim 1, wherein
the processor is further configured to store the generated recognition data in the storage medium.

13. The recognition system according to claim 1, wherein
the processor is further configured to control display of the generated recognition data.

14. A recognition device mountable on a host moving object, the recognition device comprising:
a computer-readable non-transitory storage medium; and
a processor, by executing a program stored in the computer-readable non-transitory storage, configured to recognize, in a scan space, a target moving object that is movable in the scan space by scanning the target moving object using a scanning device mounted on the host moving object,
wherein the processor is configured to:
acquire three-dimensional scan data representing a scan point group generated by scanning of the scan space;
read, from a storage medium, a three-dimensional dynamic map representing a mapping point group generated by mapping of an object present in the scan space; and
cluster the scan point group based on identification information for identifying a state of the scan space in each of multiple three-dimensional voxels into which the scan space is divided in the three-dimensional dynamic map and generate recognition data by recognizing the target moving object present between multiple stationary objects which are spaced apart from each other in front-rear relation along a scan direction of the scanning device in the scan space.

15. A recognition device mountable on a host moving object, the recognition device comprising:
a computer-readable non-transitory storage medium; and
a processor, by executing a program stored in the computer-readable non-transitory storage, configured to recognize, in a scan space, target moving objects that are movable in the scan space by scanning the target moving objects using a scanning device mounted on the host moving object,
wherein the processor is configured to:
acquire three-dimensional scan data representing a scan point group generated by scanning of the scan space;
read, from a storage medium, a three-dimensional dynamic map representing a mapping point group generated by mapping of an object present in the scan space; and
cluster the scan point group based on identification information for identifying a state of the scan space in each of multiple three-dimensional voxels into which the scan space is divided in the three-dimensional dynamic map and generate recognition data by recognizing the target moving objects, which are overlapped with one another in the scan space when viewed in a scan direction of the scanning device.

16. A recognition method to be executed by a processor to recognize, in a scan space, a target moving object that is movable in the scan space by scanning the target moving object using a scanning device mounted on a host moving object, the recognition method comprising:
acquiring three-dimensional scan data representing a scan point group generated by scanning of the scan space;
reading, from a storage medium, a three-dimensional dynamic map representing a mapping point group generated by mapping of an object present in the scan space;
clustering the scan point group based on identification information for identifying a state of the scan space in each of multiple three-dimensional voxels into which the scan space is divided in the three-dimensional dynamic map; and
generating recognition data by recognizing the target moving object present between multiple stationary objects which are spaced apart from each other in front-rear relation along a scan direction of the scanning device in the scan space.

17. A recognition method to be executed by a processor to recognize, in a scan space, target moving objects that are movable in the scan space by scanning the target moving objects using a scanning device mounted on a host moving object, the recognition method comprising:
acquiring three-dimensional scan data representing a scan point group generated by scanning of the scan space;
reading, from a storage medium, a three-dimensional dynamic map representing a mapping point group generated by mapping of an object present in the scan space;
clustering the scan point group based on identification information for identifying a state of the scan space in each of multiple three-dimensional voxels into which the scan space is divided in the three-dimensional dynamic map; and
generating recognition data by recognizing the target moving objects, which are overlap with one another in the scan space when viewed in a scan direction of the scanning device.

18. A recognition program product stored in a computer-readable non-transitory storage medium, the recognition program product comprising instructions to be executed by a processor to recognize, in a scan space, a target moving object that is movable in the scan space by scanning the target moving object using a scanning device mounted on a host moving object, the instructions comprising:
acquiring three-dimensional scan data representing a scan point group generated by scanning of the scan space;
reading, from a storage medium, a three-dimensional dynamic map representing a mapping point group generated by mapping of an object present in the scan space;
clustering the scan point group based on identification information for identifying a state of the scan space in each of multiple three-dimensional voxels into which the scan space is divided in the three-dimensional dynamic map; and
generating recognition data by recognizing the target moving object present between multiple stationary objects which are spaced apart from each other in front-rear relation along a scan direction of the scanning device in the scan space.

19. A recognition program product stored in a computer-readable non-transitory storage medium, the recognition program product comprising instructions to be executed by a processor to recognize, in a scan space, target moving objects that are movable in the scan space by scanning the target moving objects using a scanning device mounted on a host moving object, the instructions comprising:
acquiring three-dimensional scan data representing a scan point group generated by scanning of the scan space;
reading, from a storage medium, a three-dimensional dynamic map representing a mapping point group generated by mapping of an object present in the scan space;
clustering the scan point group based on identification information for identifying a state of the scan space in each of multiple three-dimensional voxels into which the scan space is divided in the three-dimensional dynamic map; and
generating recognition data by recognizing the target moving objects, which are overlap with one another in the scan space when viewed in a scan direction of the scanning device.
